(19) United States
(12) Patent Application Publication
(10) Pub. No.: US 2015/0046416 A1
(43) Pub. Date: Feb. 12, 2015

(54) Method for writing and reading data

(71) Applicants: René-Michael Cordes, Mannsworth (AT); Ernesto Schobesberger, Wien (AT)

(72) Inventors: René-Michael Cordes, Mannsworth (AT); Ernesto Schobesberger, Wien (AT)

(21) Appl. No.: 14/374,423

(22) PCT Filed: Jan. 22, 2013
(86) PCT No.: PCT/AT2013/000010

§ 371 Date: Oct. 29, 2014

(30) Foreign Application Priority Data
Jan. 26, 2012 (AT) A 106/2012

(51) Int. Cl. G06F 17/30; G06F 5/01

(52) U.S. Cl. CPC G06F 17/30336; G06F 5/01
USPC 707/696

(57) ABSTRACT

A method for writing and reading data into or out of an indexed dataset includes a data structure and an associated index structure, a processing unit that receives data to be written in plain text and writes the data to the data structure by means of write access and updates index data in the index structure. The processing unit detects data to be read out or the memory location thereof by means of access to the index data and reads out a data from the data structure by means of read access and makes the same available in plain text. The data in the data structure and the index data in the index structure are stored in an encrypted manner. Write/read access of the processing unit to the index structure and to the data structure take place via at least one en- and decryption unit.

The invention relates to a method for writing and reading data into or out of an indexed dataset, which comprises a data structure and an associated index structure, a processing unit receiving data to be written in plain text and writing to the data structure by means of write access and updating index data in the index structure and the processing unit detecting data to be read out or the memory location thereof by means of access to the index data and reading out the data to be read out from the data structure by means of read access and making the same available in plain text.

The invention furthermore relates to a device for writing and reading data into and out of an indexed dataset, which comprises a data structure and an associated index structure, comprising a processing unit, in which the data to be written can be received in plain text and which has write access to the data structure, in order to write the data to the data structure, and which interacts with the index structure, in order to update index data in the index structure, and which has access to the index data, in order to detect data to be read out or the memory location thereof, and which has read access to the data structure, in order to read out the data to be read out from the data structure and to make the same available in plain text.

At present, indexed datasets, particularly indexed databases, constitute the most widespread mass storage of data. From a technical hardware viewpoint, an indexed database is a mass storage device, which has a connected index memory to accelerate access. A database index is an index structure in a database, which is separated from the data structure and accelerates searching and sorting for certain fields. An index consists of a collection of pointers (references), which define an order relation to one of a plurality of columns in a table. If an indexed column is called upon as a search criterion during a query, a processing unit, that is generally a database management system, searches the desired data records on the basis of these pointers. Without an index, the column would have to be searched sequentially, which would take up much time, even with fast hardware. There is a multiplicity of different index structures. However, B⁺ trees are generally used.

It is desirable to encrypt databases, in order to protect access to the content of the database from unauthorised access. In this case, rapid access to the encrypted data should be retained, however, i.e. having to decrypt the entire database before only one or a plurality of certain data records are accessed by means of a search query should be avoided. It would therefore be desirable that only the data records to be read out or the data records to be written are encrypted in each case.

Secure protection of the database is only ensured if not only the data stored in the data structure, but also the index data stored in the index structure are present in an encrypted manner.

If data are encrypted, it is a functional requirement that the same can be placed in a clear relationship to the code used for encryption. The following problems arise when indexing encrypted data: When encrypting the data, it must be possible for the processing unit to recognise the content of the data. Whether the size of the data on the storage medium is changed during encryption must furthermore be taken into account. When decrypting the data, it is to be ensured that the key used for encryption is available again.

The invention therefore aims to create a method and a device, using which, the integrity of the data structure and the index structure of a dataset can be protected, without access to the data by authorised users using the index being impaired. The unrestricted functionality of an indexed data base should be retained.

To achieve this object, it is provided according to a first aspect of the invention, that the data in the data structure and the index data in the index structure are stored in an encrypted manner and that write/read access of the processing unit to the index structure and to the data structure takes place via at least one en- and decryption unit, using which the data are en- or decrypted by means of stream cipher. The fact that the data to be written and to be read are en- or decrypted by means of stream cipher ensures that the image of the encrypted data and the unencrypted data on the storage medium has exactly the same dimensions (bit length), so that the same are located in a bit-precise manner, even in encrypted form and can be transmitted to the requesting user without knowing the content. As each individual piece of information has exactly the same dimensions (bit length) as the unencrypted version, it is even possible to access the position of the encrypted data exactly from an index created in unencrypted form, so that the content of the encrypted data does not have to be recognised by the processing unit of the database and no consideration has to be given to the factor of encryption during storage location searching.

Stream cipher is a cryptographic algorithm, in which plain-text characters are individually linked with the characters of a key stream. In the case of stream cipher of digital data—only the characters 0 and 1 are used—the linking of the plain-text stream with the key stream takes place with the aid of the XOR function. The key stream is a pseudo-random character sequence. Most stream ciphers use a symmetrical key. The key determines the initial state of the system.

Preferably, in the context of the invention, the procedure is such that the generation of the key stream for the stream cipher takes place using at least one feedback shift register, which is filled with a defined sequence of bits for the initialisation thereof. Linear feedback shift registers can be implemented effectively both directly in hardware, such as for example FPGAs, and in software. Feedback shift registers are fast and produce pseudo-random sequences with good statistical properties. A feedback shift register is realised in digital technology as a shift register with n storage elements. The individual storage elements are typically D flip flops, which can each store one bit. By contrast with a conventional shift register, there are branches between certain D flip flops, which constitute the feedback. An XOR function is generally used in each case for the feedback. Instead of the XOR link, an XNOR link can however also be used.

For initialisation, the shift register with XOR feedback can be filled with random values, which determine the key stream generated by the shift register in the sequence. Like any other shift register, the feedback shift register also has a clock input: For each clock pulse, a change is made to the successor state; i.e. if a bit should be output, all of the bits in the shift register are shifted by one storage location; the new bit at the end of the shift register is calculated as a function of the other bits. This process counts as one clock. To completely run through all combinations, 2ⁿ−1 clock pulses are required. A code sequence of this type therefore has a length of 2ⁿ−1 bits (n=number of code-generating storage elements of the shift register connected in series). A plurality of linear feedback shift registers are generally used as key stream generator, which for the most part are of different length and have different feedback polynomials. Thus, one combines linear feedback shift registers to form non-linear generators.

The larger the length of the code sequence of the key stream or the code is, the harder it is to decrypt the same. For example, an infinite code would not have to be hidden, as it is never known entirely. Functionally, any code, which does not repeat before the end of the information to be encrypted, is to be regarded as infinite. A functionally infinite code has the disadvantage that it cannot be transmitted; it must be generated.

Disadvantageous in the case of code generators in the form of conventional feedback shift registers is the fact that it is easily possible to infer the structure of the generator from the code sequence, so that the same can be re-generated using an identically built generator. An increase in security is achieved according to a preferred procedure in the context of the invention in that for each write access of the processing unit to the data structure or the index structure, a different key stream is used. This means that the feedback shift register(s) is or are re-initialised for encrypting each data packet. Preferably, the procedure is such here, that in each case at least one first sequence of bits and a second sequence of bits is used for initialising the feedback shift register(s). This takes place in particular if only one single feedback shift register is used for generating the key stream in such a manner that the first and the second sequences of bits are linked with the aid of an XOR function and the sequence of bits resulting from the linking is fed to the feedback shift register for initialisation. Alternatively, specifically for the case that at least two mutually connected feedback shift registers are used for generating the key stream, the procedure is such that at least one first feedback shift register is filled with the first sequence of bits for its initialisation and at least one second feedback shift register is filled with the second sequence of bits for its initialisation.

In the context of the invention, it must be ensured that the encryption of a section of the dataset, such as e.g. a dataset of the database and the encryption of the same section or data record are synchronised with one another, that is to say that the encryption and the decryption takes place using the same key stream. This means that the code generator must be returned to the point of the start of the encryption. The synchronisation preferably takes place using the indices of the data records. In particular, the procedure is such that an index number assigned to the data record to be encrypted or decrypted is chosen as first sequence of bits or that the first sequence of bits is generated from the same. The primary index is preferably used for this. The second sequence of bits is preferably a unique identifier of the database or is generated from the same.

A higher security results if, as corresponds to a further preferred procedure, a third sequence of bits is furthermore used for initialising the feedback shift register(s). The third sequence of bits is in this case advantageously a unique identifier of the respective user or generated from the same. The third sequence of bits is preferably fed to a third feedback shift register for initialisation.

A further advantage of the method according to the invention is the fact that the generation of the key stream for the stream cipher can begin as soon as at least one of the feedback shift registers is filled with the first bit from the respective sequence of bits. In particular, the feedback shift registers are filled with the respective sequence of bits at the same time.

The structure of the key stream generator is preferably such that at least one XOR gate is used for the feedback of the shift register(s), as is known per se. The complexity of the generator can be increased in this manner in that the feedback shift registers are connected to one another in such a manner that the at least one XOR gate of the one shift register is switched on or off depending on the state of the other shift register.

An extremely preferred development results if a code generator, as is described in WO 03/075507 A1, comes to be used, whereby reference is made to the Claims 15 and 16 and also 33 and 38 of the present application. In the case of such a code generator, the encryption cannot even be broken if both the structure of the code generator and the algorithm running in the same are known. The structure of the generator is namely of such a type that it is in a position to generate such a high number of different codes with such a long length, that the discovery of the currently used code and the currently produced position in the code sequence is only possible with an extremely low possibility. The code cannot be re-generated if the generator can create so many different codes that it is not possible to draw a conclusion from a section of the individual code about the continuation thereof.

The access of a user computer to the dataset or the database generally takes place from a remote location via a data communication connection, particularly via a computer network. The access of a user computer to the data structure and the index structure in this case takes place via the processing unit. As the data are present in the processing unit in plain text, it is advantageous to create measures to prevent user computers from gaining access to these plain-text data. In this connection, the invention preferably provides that the data transmitted between the processing unit and a user computer are transmitted in an encrypted manner. In particular, the procedure is such that the encrypted transmission of the data between the processing unit and the user computer takes place using one en- and decryption unit assigned to the user computer and one assigned to the dataset, using which the data are en- or decrypted by means of stream cipher.

A particularly secure design is ensured in that any transmission of data from and to the processing unit takes place via at least one en- and decryption unit, using which the data are en- or decrypted by means of stream cipher. The processing unit therefore has no unencrypted input or output into/out of the surrounding network, so that it is ensured that the data memory of the processing unit, in which the data are present in plain text, cannot be seen.

According to a further aspect of the present invention, a device of the type mentioned at the beginning, for writing and reading data into or out of an indexed dataset is suggested. The device according to the invention is characterised in that the processing unit is connected to the data structure and to the index structure via at least one en- and decryption unit, using which the data can be en- or decrypted by means of a stream cipher, so that the write/read access of the processing unit to the index structure and to the data structure takes place via the at least one en- and decryption unit.

The processing unit is preferably constructed as a CPU assigned to the data structure and the index structure.

Preferred developments of the device according to the invention result from the subclaims.

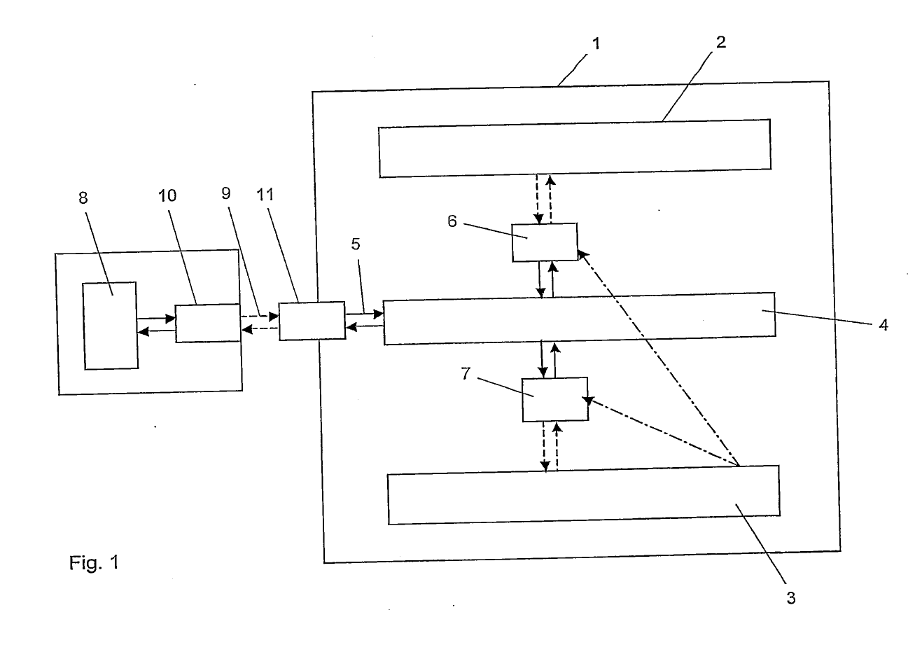

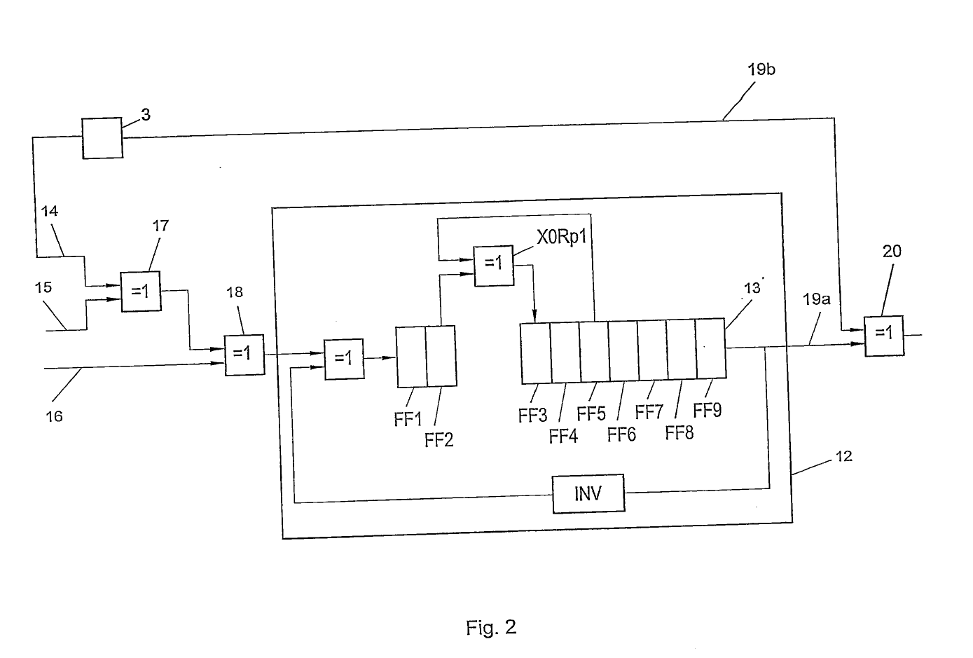

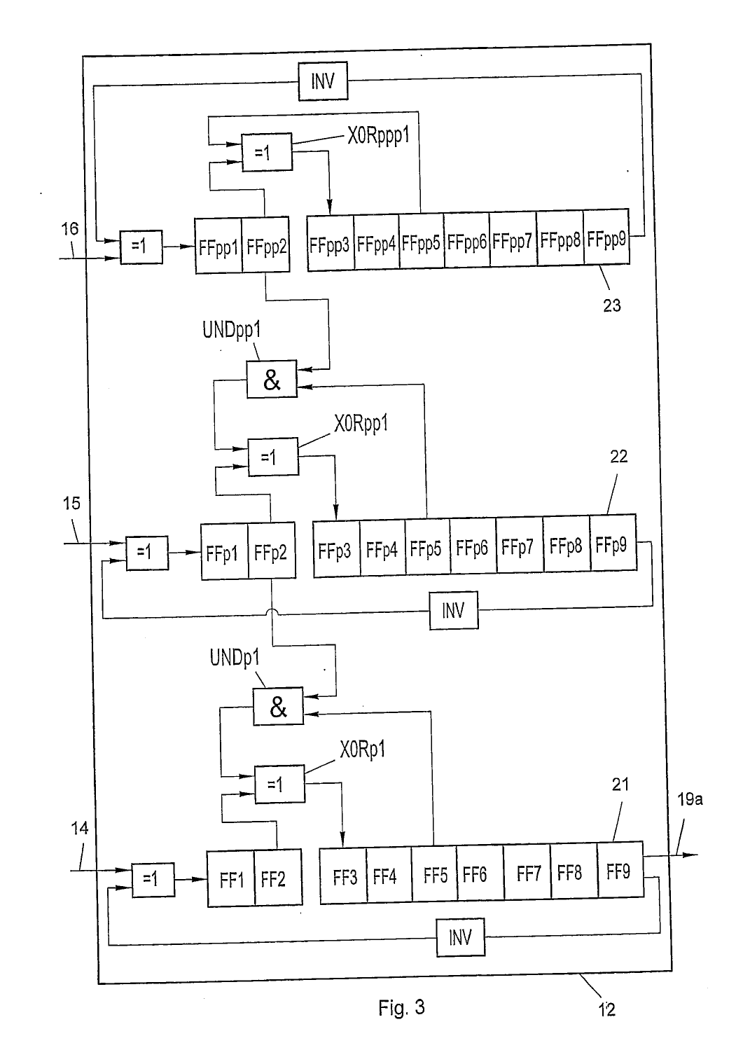

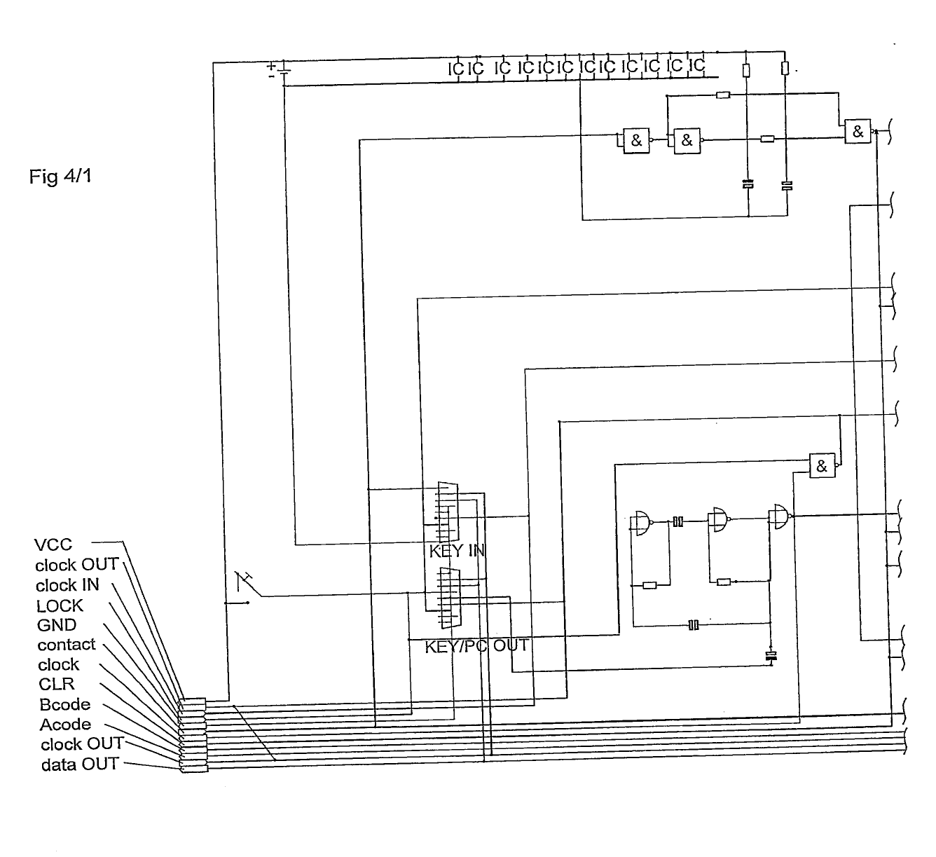

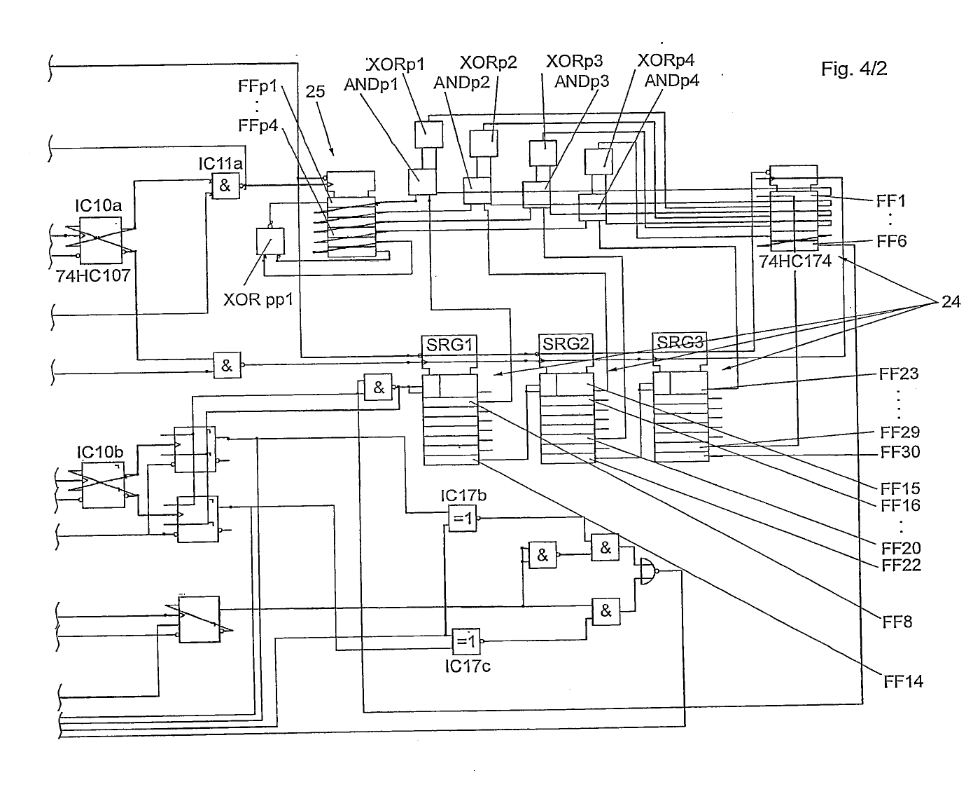

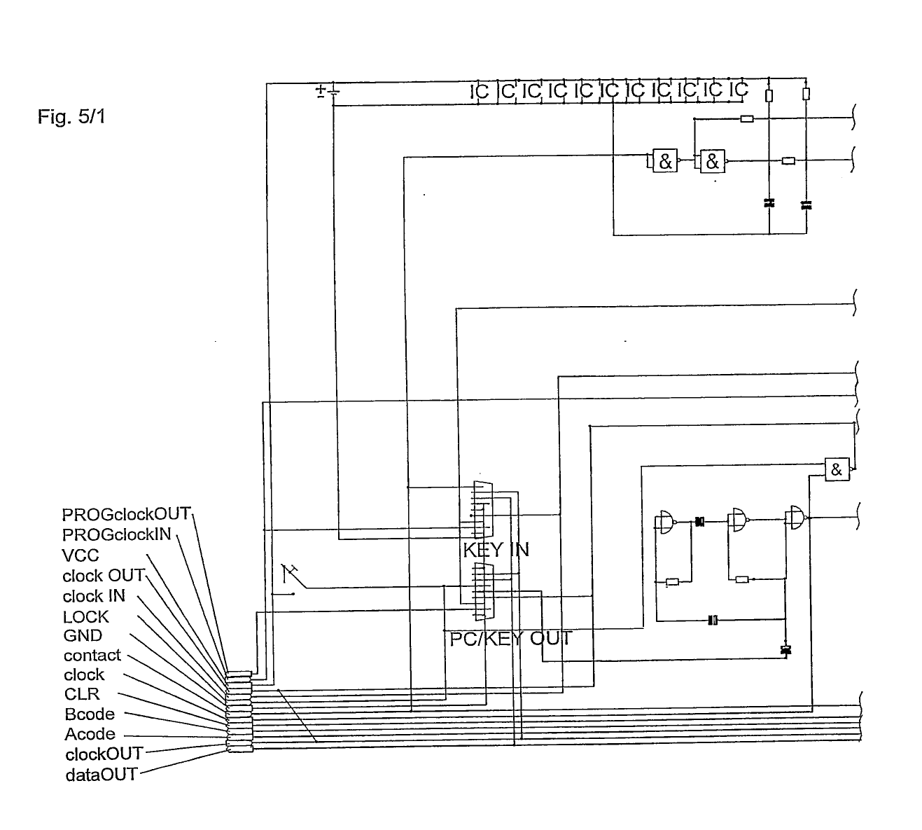

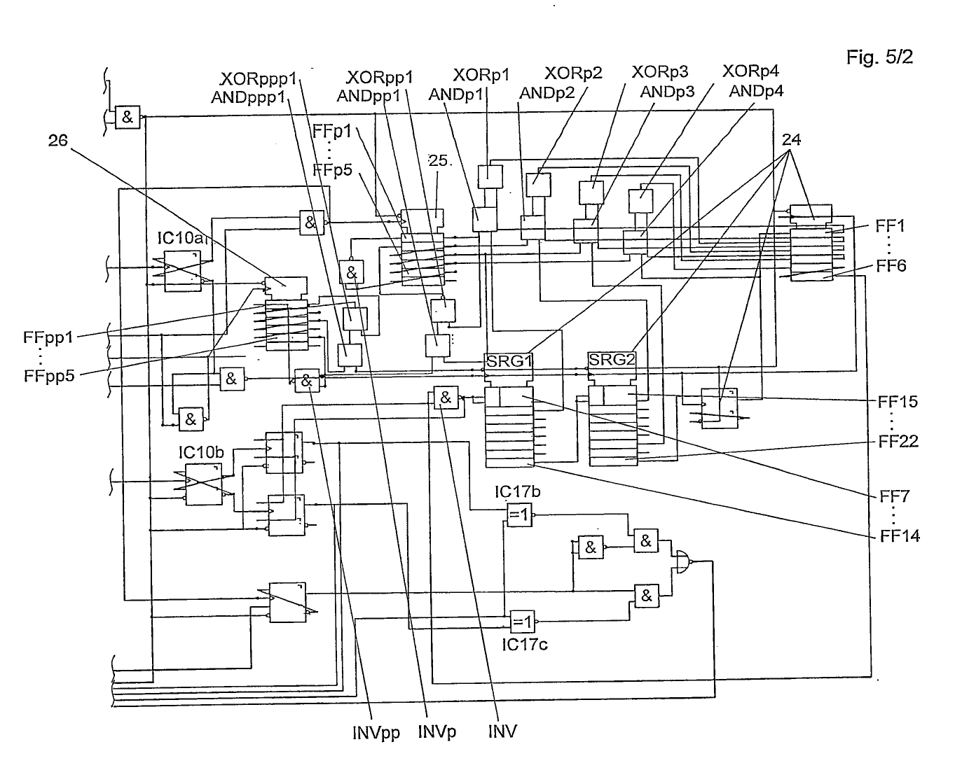

The invention is explained in more detail hereinafter on the basis of schematically illustrated exemplary embodiments. In the figures, FIG. 1 shows a database according to the invention, FIG. 2 shows the encryption and decryption process and FIG. 3, FIG. 4 and FIG. 5 show different designs of a key stream generator used in the context of the invention.

A database 1 is illustrated in FIG. 1, which comprises a data structure 2 and an index structure 3. A processing unit in the form of a CPU is designated with 4, which has an interface 5 for departing and arriving data and which controls the write and read access to the index structure 3 and the data structure 2. The processing unit 4 is connected to the data structure 2 via an en- and decryption unit 6 and to the index structure 3 via an en- and decryption unit 7, so that the write or read access to the data structure 2 and the index structure 3 takes place via the en- and decryption unit 6 or

In the processing unit 4, the data to be written to the data structure 2 or the index structure 3 and the data to be read out of the data structure 2 or the index structure 3 are present in plain text, so that the operations required for the indexing and for the location of data records can be carried out. By contrast, in the data structure 2 and in the index structure 3, the data are present in encrypted form exclusively. So that the processing unit 4 can access the encrypted data, access takes place via the en- and decryption unit 6 or 7. In FIG. 1, the transmission of the data in plain text is here shown using a solid line and the transmission of encrypted data is illustrated with a dashed line.

The en- and decryption units 6 and 7 en- and decrypt the respective data by means of stream cipher and accordingly comprise a key stream generator, which is explained in more detail on the basis of the various embodiments in FIGS. 2 to 5. Each of the subsequently described embodiments can be used in the context of the en- and decryption unit 6 and 7 or the en- and decryption unit 10 and 11 (see below).

A user computer 8 can access the database 1 via a communication connection 9. The data are transmitted via the communication connection 9 in encrypted form, the en- and decryption taking place by means of the en- and decryption units 10 and 11. The encryption and the decryption preferably takes place by means of stream cipher.

The en- and decryption units 6, 7, 10 and 11 can comprise one code generator in each case according to WO 03/075507 A1, the code generators of the en- and decryption units 6 and 7 must be synchronised for the encryption and the later decryption of data. Furthermore, the code generators of the en- and decryption units 10 and 11 must be synchronised with one another.

If a user is searching for certain information under the data stored by the same in the database 1, it inputs corresponding search words in the user computer 8. The same encrypts this input and transmits it to the database 1. In the database 1, this search term is decrypted by means of the en- and decryption unit 11 and supplied to the processing unit 4 in plain text. The processing unit 4 searches for the search term in the index structure 3, the index structure 3 of the processing unit 4 being available on a plain-text basis owing to real-time access via the en- and decryption unit 7. The index structure 3 makes the exact location of the searched data in the encrypted data structure 2. Furthermore, the encrypted data are sought in the data structure 2 and forwarded to the user computer 8 of the user in unmodified encrypted form. The user computer 8 decrypts the data with the aid of the en- and decryption unit 10, so that the same is displayed there as the requested plain-text data. Alternatively, the reading out of the encrypted data from the data structure 2 can take place by means of the en- and decryption unit 6, these data being present in the processing unit 4 in plain text and having to be encrypted again using the en- and decryption unit 11 for the purpose of transmission to the user computer 8.

The synchronisation of the en- and decryption units 6 and 7 is explained in more detail on the basis of FIG. 2. FIG. 2 shows a basic circuit of a key stream generator 12 having a shift register 13, which consists of a plurality of storage elements connected together to form a code-producing series, namely flip flops FF1, FF2, . . . FF9. An XOR gate XORp1 is interconnected in such a manner that the one input of the XOR gate XORp1 is connected to an output of the storage element FF2 located in the code-producing series and the other input of the XOR gate XORp1 is connected to an output of the storage element FF5 located in the code-producing series and an output of the XOR gate XORp1 is connected to an input of the storage unit FF3 following the storage element FF2, which is connected to the one input of the XOR gate XORp1, in the series in the flow direction—thus recursively. Furthermore, it can be seen that the last storage element FF9 is connected to the first storage element FF1 via an inverter INV. As soon as one fills the shift register 13 with a sequence of bits, one obtains a code sequence using this circuit. If, as is the case in the design according to FIG. 2, only a single shift register comes to be used, the sequences of bits 14, 15 and 16 are supplied in such a manner to the shift register 13 for the initialisation thereof, that initially, the sequences of bits 14 and 15 are linked to one another with the aid of an XOR gate 17 and the linked sequence of bits is then linked to the sequence of bits 16 with the aid of the XOR gate 18. In this case, it is preferred that the sequence of bits generated from the sequences of bits 14, 15, 16 and supplied to the shift register 13 is not longer than that corresponding to the number of storage elements in the shift register 13, as the sequence of bits would otherwise be overwritten by the sequence of bits coming from the storage elements FF9 via the inverter. The first sequence of bits 14 in this case corresponds to the index number of the relevant data record. The second sequence of bits 15 in this case corresponds to the database ID. The third sequence of bits 16 corresponds to the “Own ID” of the user.

The key stream generator 12 generates a key stream 19a. An incoming stream 19b of plain-text data is encrypted in such a manner that the bits of the bit stream 19b of the plain text are linked with the bits of a key stream 19a individually with the aid of an XOR gate 20. If the plain-text data represent a data record of the database 1, the index of this data record is determined in accordance with the inherent structuring of the database and supplied as a sequence of bits 14 to the key stream generator 12 as an initialisation sequence.

If the stream 19b is a stream of encrypted data, the same is decrypted in such a manner that the bits of the bit stream 19b of the encrypted data are linked with the bits of the key stream individually with the aid of an XOR gate 20. If the encrypted data represent an encrypted data record of the database 1, the index of this data record is determined in accordance with the inherent structuring of the database and supplied as a sequence of bits 14 to the key stream generator 12 as an initialisation sequence.

In the modified design according to FIG. 3, three shift registers 21, 22, 23 in total come to be used. The storage elements of the individual shift registers are in each case wired recursively in the same manner as in FIG. 2. The shift registers are furthermore connected to one another in such a manner that, depending on the state of the second shift register 22, the function of the XOR gate XORp1 of the recursive wiring of the first shift register 21 is switched on and off. The function of the XOR gate XORpp1 of the recursive wiring of the second shift register 22 is in turn switched on and off depending on the state of the third shift register 23. For this purpose, an output of the flip flop FFp2 or FFpp2 of the one shift register 22 or 23 is connected to an input of an AND gate ANDp1 or ANDpp1, which is input into the respective recursive function XORp1 or XORpp1 of the shift register 21 or 22.

Thus, a code generator 12 with three levels is created, the code generation being influenced at each level by initialisation of the respective shift register 21, 22 and 23 with the sequence of bits 14, 15 and 16. The initialisation can in this case preferably take place in such a manner that the first sequence of bits 14 is supplied to the shift register 21 of the first level, the second sequence of bits 15 is supplied to the shift register 22 of the second level and the third sequence of bits 16 is supplied to the shift register 23 of the third level, the sequences of bits 14, 15, 16 preferably being defined as described in FIG. 2.

In the embodiment according to FIG. 4, the structure shown in FIG. 3 is configured in an even more complex manner and longer code-producing series and a plurality of recursive wirings are provided in particular. In this case, a number of uninterrupted series-connected storage elements are realised in the form of shift registers SRG1, SRG2, . . . , which from a functional viewpoint together form a shift register 24 in the sense of the invention. The length of the code doubles for every added storage element, so that the length of the code is calculated as follows

Lc=2ⁿ−1
(Lc=length of the code sequence; n=number of code-generating series-connected storage elements)

If this unit is operated with a certain clock, the following applies for the duration of the code:

$$Tc = \frac{{2}^{n} - 1}{fc}$$

(Tc=duration until the code repeats; fc=code generation clock frequency)

With fewer than 50 storage elements for a code generation clock frequency of 384,000 bits/s, the code runs for longer than one year without the sequence repeating, so that a signal to be encrypted can simultaneously be transmitted encrypted via a fixed line and decrypted over just as long a time period, so that transmissions are possible live over just as long a time period.

If, for a corresponding length of the shift register 24, one then inserts an XOR gate XORp1,p2,p3,p4 at various positions of this shift register 24 between a storage element FF1,2,3,4 and the next storage element located in the series and then feeds the same with the signal from a third storage element FF8,15,20,23, one thus changes the code generated thereby in each case (FIG. 5).

In the case of a plurality of code-changing XOR gates XORp1,p2,p3,p4, cf. FIG. 5, it should be ensured that the various code-changing XOR gates XORp1, p2, p3, p4, the first input of which is fed from a first output of a storage element FF1,2,3,4, the second input thereof is in each case fed by an output of a storage element FF8,15,20,23, which is remote from a number of storage elements in the flow direction of the first-mentioned storage element FF1,2,3,4, which in each case corresponds to a different prime number which is larger than 1, but is not a fraction of the total number of storage elements connected in series R, so that no code-shortening resonant effects arise during the influencing of the code sequence. Therefore, there is a number of 7, 13, 17 and 19 (prime numbers) storage elements located between the corresponding storage element pairs FF1,8; FF2,15; FF3,20; FF4,23.

If one connects an output of an AND gate ANDp1 or ANDp1,p2,p3,p4, the one input of which depends on an output of the storage element FF3 or FF8,15,20,23, to one of the two inputs of the respective XORp1 or XORp1,p2,p3,p4, then one can turn this XOR gate XOR gate XORp1 or XORp1,p2,p3,p4 on or off in terms of the code-changing action of the same by means of the second input of the AND gate ANDp1,p2,p3,p4 and if one connects a further storage element FFp1,p2,p3,p4 thereto, one can make the switching on and off of the code influencing action of the XOR gate XORp1 or XORp1,p2,p3,p4 programmable. The code-programming storage elements FFp1,p2,p3,p4 can in this case be connected together to form a shift register 25. Subsequently, the code-programming storage elements FFp1,p2,p3,p4 of the shift register 25 itself can in turn be recursively wired with the aid of an XOR gate XORpp1.

The number of programmable different codes is calculated as follows:

Nc=2^{pn}−1
(Nc=number of possible different codes; pn=number of programmable XOR gates XORp1,p2, . . . pn)

If one is then in possession of an identical code generator and would like to infer the further course of the code sequence on the basis of a certain number of bits, the possibility of one detecting the correct continuation of the code sequence depends both on the number of storage elements FF1,2, . . . n used in the code generation and also the number of programmable code-changing XOR gates XORp1,p2, . . . pn. This results in a possibility of discovering the programming on which the code is based and thus predicting the further course of the code from:

$$W = \frac{Nb}{( {2}^{n} - 1 ) * ( {2}^{pn} - 1 )}$$

(Nb=number of observed bits of the code sequence; n=number of code-generating series-connected storage elements FF1,2, . . . n; pn=number of XOR gates XORp1,p2, . . . pn changing the codes in a programmable manner)

### EXAMPLE

233 is the 52nd prime number. If one does not use 1 and 233 expresses the total number of storage elements connected in series, then there are 50 different storage elements on this stretch, which are in each case located remotely from an output storage element, which corresponds to a primary number (np=50). As each recursive XOR gate 1-50 is in each case switched on in series between a next storage element 1-50 starting from the first, the total length of the storage elements is extended to (n=233+50=283).

Thus:

$$W = \frac{Nb}{( {2}^{n} - 1 ) * ( {2}^{pn} - 1 )} = \frac{Nb}{( {2}^{283} - 1 ) * ( {2}^{50} - 1 )}$$

$$W = \frac{Nb}{( 1.5541351138 * {10}^{85} - 1 ) * ( 1.1258999068 * {10}^{15} - 1 )}$$

$$W ∼ \frac{Nb}{1.7498005798 * {10}^{100}}$$

In other words, the code sequence must be observed for 1.7498005798*10¹⁰⁰ clock cycles so that one discovers a certain sequence with the possibility 1. If the clock frequency is 384000 Hz, this results in an observation time of 1.4449430312*10⁸⁷ years.

By wiring the code-programming storage elements (FFp1,p2,p3,p4,p5,p6) of the shift register 25 to one another recursively, so that they run through all possible state combinations within the time interval

$$Tpn = \frac{{2}^{pn} - 1}{fp}$$

(T pn=run-through time for all possible programming states; pn=number of programming storage elements; fp=programming clock frequency)
   the programming results from a certain time period, in which the code-programming storage elements are supplied with a program clock.

So that the programming cannot be discovered even approximately from the program duration, the programming can take place in a two-stage manner. To this end, a further programming level can be added, in that the code-programming XOR gate XORpp1 itself if in turn connected to a storage-element series RRR with the interposition of an AND gate ANDpp1 and thus made programmable, an XOR gate XORppp1 being used in turn for recursive wiring of the shift register 26 (FIG. 6).

Starting from the above calculation example, it is thereby ensured that the (2²⁸³−1)*(2⁵⁰−1) different states are broken down into 2⁵⁰−1 different sections, of which one is selected in the first programming phase. This selection process takes place in at most 2^{ppn}−1 steps (ppn=number of prime numbers, which are contained in the number of prime numbers (50) used during the programming, that is to say 16). This means that at most 2¹⁶ cycles must take place before all of the sections are found. At a programming clock frequency of 1 MHz, this process is completed in 0.065 seconds. A time period, which is covered well for each programming, as it lies below human reaction time, which is why it is ensured that no conclusions about the programming of the keys can be drawn from the actual elapsed programming time.

1-39. (canceled)

40. A method for writing and reading data into or out of an indexed dataset (1), which comprises a data structure (2) and an associated index structure (3), wherein a processing unit (4) receives data to be written in plain text and writes to the data structure (2) by means of write access and updates index data in the index structure (3) and wherein the processing unit (4) detects data to be read out or the memory location thereof by means of access to the index data (3) and reads out the data to be read out from the data structure (2) by means of read access and makes the same available in plain text, wherein the data in the data structure (2) and the index data in the index structure (3) are stored in an encrypted manner and in that write/read access of the processing unit (4) to the index structure (3) and to the data structure (2) takes place via at least one en- and decryption unit (6, 7), using which the data are en- or decrypted by means of stream cipher.

41. The method according to claim 40, wherein generation of a key stream for the stream cipher takes place using at least one feedback shift register (13; 21, 22, 23; 24, 25; 24, 25, 26), which is filled with a defined sequence of bits for the initialisation thereof.

42. The method according to claim 41, wherein for each write access, a different key stream is used.

43. The method according to claim 41, wherein in each case at least one first sequence of bits (14) and a second sequence of bits (15) is used for initialising the feedback shift register(s) (13; 21, 22, 23; 24, 25; 24, 25, 26).

44. The method according to claim 43, wherein the first and the second sequences of bits (14, 15) are linked with the aid of an XOR function (17) and the sequence of bits resulting from the linking is fed to the feedback shift register (13) for initialisation.

45. The method according to claim 43, wherein at least one first feedback shift register (21, 24) is filled with the first sequence of bits (14) for its initialisation and at least one second feedback shift register (22, 25) is filled with the second sequence of bits (15) for its initialisation.

46. The method according to claim 43, wherein an index number assigned to the data record to be encrypted or decrypted is chosen as first sequence of bits (14).

47. The method according to claim 43, wherein the second sequence of bits (15) is generated from a unique identifier of the database.

48. The method according to claim 43, wherein a third sequence of bits (16) is furthermore used for initialising the feedback shift register(s) (13; 21, 22, 23; 24, 25; 24, 25, 26).

49. The method according to claim 48, wherein the third sequence of bits (16) is generated from a unique identifier of the respective user.

50. The method according to claim 48, wherein the third sequence of bits (16) is fed to a third feedback shift register (23, 26) for initialisation.

51. The method according to claim 45, wherein the feedback shift registers (13; 21, 22, 23; 24, 25; 24, 25, 26) are filled with the respective sequence of bits (14, 15, 16) at the same time.

52. The method according of claim 41, wherein at least one XOR gate (XORp1, XORp2, XORp3, XORp4, XORpp1, XORppp1) is used for the feedback of the shift register(s) (13; 21, 22, 23; 24, 25; 24, 25, 26).

53. The method according of claim 52, wherein the feedback shift registers (13; 21, 22, 23; 24, 25; 24, 25, 26) are connected to one another in such a manner that the at least one XOR gate (XORp1, XORp2, XORp3, XORp4, XORpp1, XORppp1) of the one shift register is switched on or off depending on the state of the other shift register.

54. The method according to claim 52, wherein the at least one feedback shift register (13; 21, 22, 23; 24, 25; 24, 25, 26) has a plurality of storage elements (FF1, FF2, . . . ; FFp1, FFp2, . . . ; FFpp1, FFpp2, . . . ) connected to form a code-producing series, wherein an output of the last storage element in the series is connected to an input of the first storage element in the series to form a circuit, wherein the feedback takes place with the aid of the at least one XOR gate (XORp1, XORp2, XORp3, XORp4, XORpp1, XORppp1) in such a manner that a first input of the XOR gate is connected to an output of a storage element (FF2) located in the code-producing series, a second input of the XOR gate is connected to an output of a further storage element (FF5) located in the code-producing series and an output of the XOR gate is connected to the storage element (FF3) following the storage element connected to the first input of the XOR gate in the code-producing series.

55. The method according to claim 54, wherein an AND gate (ANDp1) is connected in a line connecting the second input of the at least one XOR gate (XORp1) and the output of the further storage element (FF5) located in the code-producing series (21, 24) in such a manner that an output of the AND gate (ANDp1) is connected to the second input of the XOR gate (XORp1), a first input of the AND gate (ANDp1) is connected to the output of the further storage element (FF5) located in the code-producing series and a second input of the AND gate (ANDp1) is connected to an output of a code-programming storage element (FFp2), wherein a storage element of a further feedback shift register (22, 25) is used as code-programming storage element, and in that preferably the output of a storage element (FF9) located in the code-producing series (21, 24) is connected to an input of an inverter (INV) and the output of the inverter (INV) is connected to the input of a different storage element (FF1) arranged in the code-producing series (21, 24).

56. The method according to claim 40, wherein the dataset (1) is a database.

57. The method according to claim 40, wherein the data transmitted between the processing unit (4) and a user computer (8) are transmitted in an encrypted manner.

58. The method according to claim 57, wherein the encrypted transmission of the data between the processing unit (4) and the user computer (8) takes place using one en- and decryption unit (11) assigned to the user computer (8) and one en- and decryption unit (11) assigned to the dataset (1), using which the data are en- or decrypted by means of stream cipher.

59. The method according to claim 40, wherein any transmission of data from and to the processing unit (4) takes place via at least one en- and decryption unit (6, 7, 11), using which the data are en- or decrypted by means of stream cipher.

60. A device for writing and reading data into and out of an indexed dataset (1), which comprises a data structure (2) and an associated index structure (3), comprising a processing unit (4), in which the data to be written can be received in plain text and which has write access to the data structure (2), in order to write the data to the data structure (2), and which interacts with the index structure (3), in order to update index data in the index structure (3), and which has access to the index data, in order to detect data to be read out or the memory location thereof, and which has read access to the data structure (2), in order to read out the data to be read out from the data structure (2) and to make the same available in plain text, wherein the processing unit (4) is connected to the data structure (2) and to the index structure (3) via at least one en- and decryption unit (6, 7), using which the data can be en- or decrypted by means of a stream cipher, so that the write/read access of the processing unit (4) to the index structure (3) and to the data structure (2) takes place via the at least one en- and decryption unit (6, 7).

61. The device according to claim 60, wherein the en- and decryption unit (6, 7) has at least one feedback shift register (13; 21, 22, 23; 24, 25; 24, 25, 26) for generating a key stream for the stream cipher, to which a defined sequence of bits is fed in each case for the initialisation thereof.

62. The device according to claim 61, wherein means for generating and/or storing at least one first sequence of bits (14) and a second sequence of bits (15) are provided, which interact with the shift register(s) (13; 21, 22, 23; 24, 25; 24, 25, 26) in such a manner that at least the first sequence of bits (14) and the second sequence of bits (15) are used for initialising the feedback shift register(s) (13; 21, 22, 23; 24, 25; 24, 25, 26).

63. The device according to claim 62, wherein the first sequence of bits (14) is fed to at least one first feedback shift register (21; 24) for the initialisation thereof and the second sequence of bits (15) is fed to at least one second feedback shift register (22; 25) for the initialisation thereof.

64. The device according to claim 62, wherein the means for generating and/or storing the first sequence of bits (14) are configured to generate the first sequence of bits (14) from an index number assigned to a data record to be encrypted or decrypted.

65. The device according to claim 62, wherein the means for generating and/or storing the second sequence of bits (15) are configured to generate the second sequence of bits (15) from a unique identifier of the database (1).

66. The device according to claim 62, wherein means of generating and/or storing at least one third sequence of bits (16) are provided, which interact with the shift register(s) (13; 21, 22, 23; 24, 25; 24, 25, 26) in such a manner that the third sequence of bits (16) is also used for initialisation of the feedback shift register(s) (13; 21, 22, 23; 24, 25; 24, 25, 26).

67. The device according to claim 66, wherein the third sequence of bits (16) is generated from a unique identifier of the respective user.

68. The device according to claim 66, wherein the third sequence of bits (16) is fed to a third feedback shift register (23, 26) for initialisation.

69. The device according to claim 62, wherein the feedback shift registers (13; 21,22,23; 24,25; 24,25,26) are simultaneously filled with the respective sequence of bits.

70. The device according to claim 61, wherein at least one XOR gate (XORp1, XORp2, XORp3, XORp4, XORpp1, XORppp1) is used for the feedback of the shift register(s) (13; 21, 22, 23; 24, 25; 24, 25, 26).

71. The device according to claim 70, wherein the feedback shift registers (13; 21, 22, 23; 24, 25; 24, 25, 26) are connected to one another in such a manner that the at least one XOR gate (XORp1, XORp2, XORp3, XORp4, XORpp1) of one shift register is switched on or off depending on the state of another shift register.

72. The device according to claim 70, wherein the at least one feedback shift register (13; 21, 22, 23; 24, 25; 24, 25, 26) has a plurality of storage elements (FF1, FF2, . . . ; FFp1, FFp2, . . . ; FFpp1, FFpp2, . . . ) connected to form a code-producing series, wherein an output of the last storage element is connected to an input of the first storage element in the series to form a circuit, wherein the feedback takes place with the aid of the at least one XOR gate (XORp1, XORp2, XORp3, XORp4, XORpp1, XORppp1) in such a manner that a first input of the XOR gate is connected to an output of a storage element (FF2) located in the code-producing series, a second input of the XOR gate is connected to an output of a further storage element (FF5) located in the code-producing series and an output of the XOR gate is connected to an input of the storage element (FF3) following the storage element in the code producing series connected to the first input of the XOR gate.

73. The device according to claim 72, wherein an AND gate (ANDp1) is connected in such a manner in a line connecting the second output of the at least one XOR gate (XORp1) and an output of the further storage element (FF5) located in the code-producing series (21; 24) that an output of the AND gate (ANDp1) is connected to the second input of the XOR gate (XORp1), a first input of the AND gate (ANDp1) is connected to an output of the further storage element (FF5) located in the code-producing series (21; 24) and a second input of the AND gate (ANDp1) is connected to an output of a code-programming storage element (FFp2) and in that preferably an output of a storage element (FF9) located in the code-producing series (21, 24) is connected to an input of an inverter (INV) and an output of the inverter (INV) is connected to an input of a different storage element (FF1) arranged in the code-producing series (21; 24), wherein a storage element of a further feedback shift register (22; 25) is used as code programming storage element.

74. The device according to claim 72, wherein a plurality of XOR gates (XORp1,p2,p3,p4) is provided, a first input of which is in each case fed by an output of a storage element (FF1,2,3,4) located in the code-producing series (21; 24) and a second input of which is in each case fed by an output of a further storage element (FF8,15,20,23) located in the code-producing series (21; 24), which is a number of storage elements remote from the storage element (FF1,2,3,4) connected to the first input in the flow direction of the series (21;24), which number in each case corresponds to a different prime number, which is greater than 1 and not a fraction of the total number of storage elements (FF1,2, . . . n) connected in series (21; 24).

75. The device according to claim 73, wherein a plurality of code-programming storage elements (FFp1,p2,p3,p4, . . . pn) assigned to an AND gate (ANDp1,p2,p3,p4) and an XOR gate (XORp1,p2,p3,p4) in each case is provided and connected in a closed series (22; 25) to form a circuit and at least one XOR gate (XORpp1) is arranged, a first input of which is connected to an output of a storage element (FFp6) located in the code-programming series (22; 25), a second input of which is connected to an output of a further storage element (FFp5) located in the code-programming series (22; 25) and an output of which is connected to an input of the storage element (FFp1) following the storage element (FFp6) connected to the first input of the XOR gate (XORpp1) in the code-programming series (22; 25).

76. The device according to claim 75, wherein the AND gate (ANDpp1) is connected in such a manner in the line connecting the second input of the at least one XOR gate (XORpp1) and the output of the further storage element (FFp3) located in the code-programming series (22; 25) that the output of the AND gate (ANDpp1) is connected to the second input of the XOR gate (XORpp1), a first input of the AND gate (ANDpp1) is connected to the output of the further storage element (FFp3) located in the code-programming series (22; 25) and a second input of the AND gate (ANDpp1) is connected to the output of a storage element (FFpp5) used for the programming of the code-programming series (22; 25).

77. The device according to claim 76, wherein a plurality of storage elements (FFpp1,pp2,pp3,pp4, . . . ppn) used for programming the code-programming series (22; 25) and assigned to the AND gate (ANDpp1) and the XOR gate (XORpp1) in each case is provided and connected in a closed series (23; 26) to form a circuit and at least one XOR gate (XORppp1) is arranged, a first input of which is connected to an output of a storage element (FFpp1) located in the series (23; 26), a second input of which is connected to an output of a further storage element (FFpp3) located in the series (23; 26) and an output of which is connected to an input of the storage element (FFpp2) following the storage element (FFpp1) connected to the first input of the XOR gate (XORppp1) in the series (23; 26).

80. A dataset, comprising a data-containing data structure (2) and an associated index structure (3) containing index data, wherein the data in the data structure (2) and the index data in the index structure (3) are stored in an encrypted manner by means of stream cipher.

81. A dataset according to claim 80, wherein the dataset is a database (1).
